(19) United States
(12) Patent Application Publication
(10) Pub. No.: US 2010/0036057 A1
(43) Pub. Date: Feb. 11, 2010

(54) RUBBER COMPOSITION AND PNEUMATIC TIRE USING THE SAME

(75) Inventor: Noriko Mori, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Chuo-ku ,Tokyo (JP)

(21) Appl. No.: 12/160,793

(22) PCT Filed: Jan. 16, 2007
(86) PCT No.: PCT/JP2007/050523

§ 371 Date: Mar. 5, 2009

(30) Foreign Application Priority Data
Jan. 16, 2006 (JP) 2006-007521

(51) Int. Cl. C08F 8/00

(52) U.S. Cl. 525/192

(57) ABSTRACT

This invention relates to a rubber composition capable of highly improving a steering stability without deteriorating fracture characteristics and wear resistance of a tire by using in a tread rubber of the tire, and more particularly to a rubber composition comprising 10 to 200 parts by mass of a component (B): an aromatic vinyl compound-conjugated diene compound copolymer or a conjugated diene compound polymer having a weight average molecular weight as measured through a gel permeation chromatography and converted to polystyrene of 1.0×10³ to 2.0×10⁵ based on 100 parts by mass of a component (A): an aromatic vinyl compound-conjugated diene compound copolymer or a conjugated diene compound polymer having a weight average molecular weight as measured through a gel permeation chromatography and converted to polystyrene of 3.0×10⁵ to 3.0×10⁶, wherein not less than 10% but less than 60% of an unsaturated bond in a conjugated diene compound portion of the component (A) is hydrogenated.

### TECHNICAL FIELD

This invention relates to a rubber composition and a pneumatic tire using the rubber composition in a tread rubber, and more particularly to a rubber composition capable of balancing steering stability, wear resistance and fracture characteristics of a tire at high levels by using in a tread rubber.

### BACKGROUND ART

Recently, a more excellent steering stability, particularly a more excellent steering stability on a dry road surface is required as a tire performance with a highly advance of engine performances in an automobile. On the other hand, it is an important issue to ensure the wear resistance and fracture characteristics of the tire in view of economical efficiency and safety. Under such circumstances, various techniques are heretofore developed for improving the steering stability of the tire. In this context, it is known that a loss property (tan δ) at a temperature above room temperature is generally important as a development indicator for a rubber composition contributing to a steering stability of a tire, and it is effective to increase a hysteresis loss at a temperature above room temperature of a rubber composition to be used in a tread rubber of a tire in order to improve the steering stability of the tire.

For example, JP-A-S61-203145 and JP-A-S63-101440 disclose a method using a liquid polymer having a weight average molecular weight of tens of thousands as a technique for increasing the hysteresis loss of the rubber composition.

Further, JP-B-H8-30125 discloses a method compounding a hydrogenated liquid polymer having a weight average molecular weight of 5000 to 200000 into a partially hydrogenated high-molecular weight polymer as a technique for increasing the hysteresis loss of the rubber composition.

### DISCLOSURE OF THE INVENTION

The liquid polymers described in JP-A-S61-203145 and JP-A-S63-101440 have a weight average molecular weight of tens of thousands and their molecular weight is relatively low, but they have many crosslinkable double bonds and a part thereof forms cross-linkages with a rubber as a matrix to be incorporated into the matrix. Therefore, there is a problem in that the hysteresis loss is not sufficiently caused.

Further, in the method described in JP-B-H8-30125, a hydrogenation ratio of the high-molecular weight polymer constituting a matrix of the rubber composition is excessively high to adversely affect a crosslinking mode of the rubber composition, so that there is a problem in that fracture characteristics are deteriorated.

It is, therefore, an object of the invention to solve the above-mentioned problems of the conventional techniques and to provide a rubber composition capable of improving a steering stability without deteriorating fracture characteristics and wear resistance of a tire by using in a tread rubber of the tire. Also, it is another object of the invention to provide a pneumatic tire using such a rubber composition in a tread rubber and balancing the steering stability, the wear resistance and the fracture characteristics at high levels.

The inventor has made various studies in order to achieve the above objects and discovered that the steering stability can be highly improved without deteriorating the fracture characteristics and wear resistance by using a rubber composition formed by compounding a low-molecular weight aromatic vinyl compound-conjugated diene compound copolymer or conjugated diene compound polymer having the specified molecular weight (component B) into a high-molecular weight aromatic vinyl compound-conjugated diene compound copolymer or conjugated diene compound polymer having the specified molecular weight and hydrogenation ratio (component A) in the tread rubber of the tire, and as a result the invention has been accomplished.

That is, the rubber composition according to the invention comprises 10 to 200 parts by mass of a component (B): an aromatic vinyl compound-conjugated diene compound copolymer or a conjugated diene compound polymer having a weight average molecular weight as measured through a gel permeation chromatography and converted to polystyrene of 1.0×10³ to 2.0×10⁵ based on 100 parts by mass of a component (A): an aromatic vinyl compound-conjugated diene compound copolymer or a conjugated diene compound polymer having a weight average molecular weight as measured through a gel permeation chromatography and converted to polystyrene of 3.0×10⁵ to 3.0×10⁶, and is characterized in that not less than 10% but less than 60% of an unsaturated bond in a conjugated diene compound portion of the component (A) is hydrogenated.

In a preferable embodiment of the rubber composition according to the invention, the component (A) is one formed by polymerizing with a lithium-based polymerization initiator.

In another preferable embodiment of the rubber composition according to the invention, the component (A) is a partially hydrogenated styrene-butadiene copolymer. In this context, a bound styrene content of the component (A) is preferably within a range of 20 to 40% by mass. In this case, the wear resistance of the rubber composition can be improved while ensuring the fracture characteristics. Also, a vinyl bond content in a butadiene portion of the component (A) is preferably within a range of 30 to 60%. In this case, the steering stability and wear resistance of the tire can be sufficiently improved, because wet-skid resistance and wear resistance of the rubber composition are high.

In another preferable embodiment of the rubber composition according to the invention, 30% to 50% of the unsaturated bond in the conjugated diene compound portion of the component (A) is hydrogenated. In this case, the hysteresis loss at a temperature above room temperature of the rubber composition is very high, and further breaking strength and modulus of the rubber composition are high.

In another preferable embodiment of the rubber composition according to the invention, a bound styrene content of the component (B) is 0 to 60% by mass. In this case, it is not resinified to make the rubber composition hard, and wet-skid resistance and dry gripping property are good.

In the rubber composition according to the invention, it is preferable that 20% to 100% of an unsaturated bond in a conjugated diene compound portion of the component (B) is hydrogenated. In this case, the hysteresis loss at a temperature above room temperature of the rubber composition is high. Moreover, it is more preferable that 40% to 90% of the unsaturated bond in the conjugated diene compound portion of the component (B) is hydrogenated. In this case, the hysteresis loss at a temperature above room temperature of the rubber composition is very high, and further the component (B) can be easily produced.

In another preferable embodiment of the rubber composition according to the invention, the component (B) has a number average molecular weight as measured through a gel permeation chromatography and converted to polystyrene of not less than 2000 but less than 30000.

The rubber composition according to the invention preferably comprises 10 to 100 parts by mass of the component (B) based on 100 parts by mass of the component (A). In this case, the steering stability of the tire can be sufficiently improved while ensuring productivity of the rubber composition.

Moreover, the pneumatic tire according to the invention is characterized by using the above rubber composition in a tread rubber.

According to the invention, there can be provided the rubber composition formed by compounding the low-molecular weight aromatic vinyl compound-conjugated diene compound copolymer or conjugated diene compound polymer having the specified molecular weight (component B) into the high-molecular weight aromatic vinyl compound-conjugated diene compound copolymer or conjugated diene compound polymer having the specified molecular weight and hydrogenation ratio (component A) and capable of highly improving the steering stability without deteriorating the fracture characteristics and wear resistance of the tire by using in the tread rubber of the tire. Also, there can be provided the pneumatic tire using such a rubber composition in the tread rubber and balancing the steering stability, the wear resistance and the fracture characteristics at high levels.

### BEST MODE FOR CARRYING OUT THE INVENTION

The invention will be described in detail below. The rubber composition according to the invention is formed by compounding 10 to 200 parts by mass of the component (B): the aromatic vinyl compound-conjugated diene compound copolymer or conjugated diene compound polymer having a weight average molecular weight as measured through a gel permeation chromatography and converted to polystyrene of 1.0×10³ to 2.0×10⁵ into 100 parts by mass of the component (A): the aromatic vinyl compound-conjugated diene compound copolymer or conjugated diene compound polymer having a weight average molecular weight as measured through a gel permeation chromatography and converted to polystyrene of 3.0×10⁵ to 3.0×10⁶, and is characterized in that not less than 10% but less than 60% of the unsaturated bond in the conjugated diene compound portion of the component (A) is hydrogenated.

The rubber composition according to the invention is high in the hysteresis loss (tan δ) at a temperature above room temperature, since it contains the low-molecular weight aromatic vinyl compound-conjugated diene compound copolymer or conjugated diene compound polymer having a weight average molecular weight of 1.0×10³ to 2.0×10⁵ (component B). A conventional rubber composition formed by compounding the component (B) into a common rubber component has a problem that the wear resistance and fracture characteristics are deteriorated as the hysteresis loss (tan δ) is increased. To the contrary, the rubber composition according to the invention can prevent the deterioration of the wear resistance and fracture resistance by using as a matrix rubber component the high-molecular weight aromatic vinyl compound-conjugated diene compound copolymer or conjugated diene compound polymer wherein a hydrogenation ratio of the unsaturated bond in the conjugated diene compound portion is not less than 10% but less than 60% (component A) to improve a compatibility of the component (A) with the component (B). Moreover, it can further improve the hysteresis loss (tan δ) at a temperature above room temperature, since entanglements of the component (A) and the component (B) are increased. Therefore, the steering stability of the pneumatic tire can be highly improved without deteriorating the fracture characteristics (safety) and wear resistance (economic efficiency) of the tire by using the rubber composition according to the invention in the tread rubber of the tire. Furthermore, since the rubber composition according to the invention has the above-mentioned properties, it can be preferably used in a belt and various industrial rubber articles.

The component (A) in the rubber composition according to the invention: the high-molecular weight aromatic vinyl compound-conjugated diene compound copolymer or conjugated diene compound polymer is required to have a weight average molecular weight as measured through a gel permeation chromatography (GPC) and converted to polystyrene of 3.0×10⁵ to 3.0×10⁶, preferably 7.0×10⁵ to 2.5×10⁶. When the weight average molecular weight as converted to polystyrene of the component (A) is less than 3.0×10⁵, the fracture characteristics of the rubber composition are deteriorated, while when it exceeds 3.0×10⁶, the viscosity of the polymer solution becomes too high and the productivity is deteriorated.

Further, not less than 10% but less than 60% of the unsaturated bond in the conjugated diene compound portion of the component (A) is required to be hydrogenated, and preferably 30% to 50% thereof is hydrogenated. When the hydrogenation ratio of the unsaturated bond in the conjugated diene compound portion of the component (A) is less than 10%, the degree of improving the hysteresis loss of the rubber composition is small and thereby the steering stability of the tire cannot be sufficiently improved, while when the hydrogenation ratio is not less than 60%, the crosslinking mode of the rubber composition is transformed and thereby the breaking strength and elastic modulus are deteriorated.

The component (A) is produced by copolymerizing an aromatic vinyl compound and a conjugated diene compound or polymerizing a conjugated diene compound, and preferably produced by copolymerizing the aromatic vinyl compound and the conjugated diene compound or polymerizing the conjugated diene compound with using a lithium-based polymerization initiator. As the aromatic vinyl compound are mentioned styrene, α-methyl styrene, 1-vinyl naphthalene, 3-vinyl toluene, ethyl vinyl benzene, divinyl benzene, 4-cyclohexyl styrene, 2,4,6-trimethyl styrene and so on. These aromatic vinyl compounds may be used alone or in a combination of two or more. On the other hand, as the conjugated diene compound are mentioned 1,3-butadiene, isoprene, 1,3-pentadiene, 2,3-dimethyl butadiene, 2-phenyl-1,3-butadiene, 1,3-hexadiene and so on. These conjugated diene compounds may be used alone or in a combination of two or more. Among the above aromatic vinyl compounds, styrene is particularly preferable. Among the above conjugated diene compounds, 1,3-butadiene is particularly preferable.

When the component (A) is the aromatic vinyl compound-conjugated diene compound copolymer and the aromatic vinyl compound as a starting material is styrene, the component (A) is preferable to have a bound styrene content of 20 to 40% by mass. When the bound styrene content of the component (A) is less than 20% by mass, the fracture characteristics of the rubber composition are deteriorated, while when it exceeds 40% by mass, the wear resistance of the rubber composition is deteriorated.

Further, when the conjugated diene compound as a starting material of the component (A) is 1,3-butadiene, the component (A) is preferable to have a vinyl bond content in the butadiene portion of 30 to 60%. When the vinyl bond content in the butadiene portion of the component (A) is less than 30%, the wet-skid resistance of the rubber composition is insufficient and thereby the steering stability of the tire cannot be sufficiently improved, while when it exceeds 60%, the wear resistance of the rubber composition is deteriorated.

On the other hand, the component (B) in the rubber composition according to the invention: the low-molecular weight aromatic vinyl compound-conjugated diene compound copolymer or conjugated diene compound polymer is required to have a weight average molecular weight as measured through a gel permeation chromatography (GPC) and converted to polystyrene of 1.0×10³ to 2.0×10⁵. When the weight average molecular weight as converted to polystyrene of the component (B) is less than 1.0×10³, the fracture characteristics, wear resistance, wet-skid resistance and dry gripping property of the rubber composition are insufficient and thereby the fracture characteristics, wear resistance and steering stability of the tire cannot be balanced at high levels, while when it exceeds 2.0×10⁵, the wet-skid resistance and dry gripping property of the rubber composition are insufficient and thereby the steering stability of the tire cannot be improved. Moreover, the component (B) preferably has a number average molecular weight as measured through a gel permeation chromatography and converted to polystyrene of not less than 2000 but less than 30000.

The component (B) is produced by copolymerizing an aromatic vinyl compound and a conjugated diene compound or polymerizing a conjugated diene compound. As the aromatic vinyl compound are mentioned styrene, α-methyl styrene, 1-vinyl naphthalene, 3-vinyl toluene, ethyl vinyl benzene, divinyl benzene, 4-cyclohexyl styrene, 2,4,6-trimethyl styrene and so on. These aromatic vinyl compounds may be used alone or in a combination of two or more. On the other hand, as the conjugated diene compound are mentioned 1,3-butadiene, isoprene, 1,3-pentadiene, 2,3-dimethyl butadiene, 2-phenyl-1,3-butadiene, 1,3-hexadiene and so on. These conjugated diene compounds may be used alone or in a combination of two or more. Among the above aromatic vinyl compounds, styrene is particularly preferable. Among the above conjugated diene compounds, 1,3-butadiene is particularly preferable.

Further, the component (B) preferably has a bound styrene content of 0 to 60% by mass. When the bound styrene content of the component (B) exceeds 60% by mass, the component (B) is resinified to make the rubber composition hard, and the wet-skid resistance and dry gripping property are deteriorated and thereby the steering stability of the tire may not be improved.

Furthermore, 20% to 100% of the unsaturated bond in the conjugated diene compound portion of the component (B) is preferable to be hydrogenated. When not less than 20% of the unsaturated bond in the conjugated diene compound portion of the component (B) is hydrogenated, the effect on improving the hysteresis loss at a temperature above room temperature of the rubber composition becomes large. Moreover, it is more preferable that 40% to 90% of the unsaturated bond in the conjugated diene compound portion of the component (B) is hydrogenated. When the hydrogenation ratio of the unsaturated bond in the conjugated diene compound portion of the component (B) is less than 40%, the component (B) contributes to the cross-linkage of the rubber composition, the degree of improving the hysteresis loss at 30° C. of the rubber composition is small and thereby the steering stability of the tire cannot be sufficiently improved. On the other hand, it is difficult to produce the component (B) having a hydrogenation ratio of the unsaturated bond in the conjugated diene compound portion of more than 90%.

In the rubber composition according to the invention, the component (B) is compounded in an amount of 10 to 200 parts by mass, preferably 10 to 100 parts by mass based on 100 parts by mass of the component (A). When the amount of the component (B) compounded is less than 10 parts by mass based on 100 parts by mass of the component (A), the steering stability of the tire cannot be sufficiently improved, while when it exceeds 200 parts by mass, the Mooney viscosity of the rubber composition is too low and the productivity becomes poor.

For example, the component (A) can be obtained by (co)polymerizing the above-mentioned aromatic vinyl compound and conjugated diene compound in a hydrocarbon solvent in the presence of ether or a tertiary amine with using a lithium-based polymerization initiator through the anionic polymerization and hydrogenating the resulting (co)polymer in the presence of a hydrogenation catalyst through a usual method. For example, the component (B) can be also obtained by (co)polymerizing the above-mentioned aromatic vinyl compound and conjugated diene compound in a hydrocarbon solvent in the presence of ether or a tertiary amine with using a lithium-based polymerization initiator through the anionic polymerization, and further it may be optionally hydrogenated likewise the component (A).

The hydrocarbon solvent is not particularly limited, but cycloaliphatic hydrocarbons such as cyclohexane, methyl cyclopentane, cyclooctane and the like; aliphatic hydrocarbons such as propane, butane, pentane, hexane, heptane, octane, decane and the like; and aromatic hydrocarbons such as benzene, toluene, ethylbenzene and the like can be used. These hydrocarbons may be used alone or in a combination of two or more. Among these hydrocarbons, the aliphatic hydrocarbon and cycloaliphatic hydrocarbon are preferable.

As the lithium-based polymerization initiator is preferable an organolithium compound, which includes an alkyllithium such as ethyllithium, propyllithium, n-butyllithium, sec-butyllithium, t-butyllithium or the like; an aryllithium such as phenyllithium, tolyllithium or the like; an alkenyllithium such as vinyllithium, propenyllithium or the like; an alkylene dilithium such as tetramethylene dilithium, pentamethylene dilithium, hexamethylene dilithium, decamethylene dilithium or the like; an arylene dilithium such as 1,3-dilithiobenzene, 1,4-dilithiobenzene or the like; 1,3,5-trilithiocyclohexane, 1,2,5-trilithionaphthalene, 1,3,5,8-tetralithiodecane, 1,2,3,5-tetralithio-4-hexyl-anthracene and the like. Among them, n-butyllithium, sec-butyllithium, t-butyllithium and tetramethylene dilithium are preferable, and n-butyllithium is particularly preferable. The amount of the lithium-based polymerization initiator used is determined by a polymerization rate in the reaction operation and a molecular weight of the resulting (co)polymer, but it is usually about 0.02 to 5 mg, preferably 0.05 to 2 mg as a lithium atom per 100 g of a monomer.

The polymerization reaction for obtaining the components (A) and (B) may be carried out by any one of a batch polymerization system and a continuous polymerization system. The polymerization temperature in the above polymerization reaction is preferable to be within a range of 0 to 130° C. Also, the polymerization reaction may be conducted by any polymerization types such as isothermal polymerization, temperature rise polymerization and adiabatic polymerization. Further, an allene compound such as 1,2-butadiene or the like may be added for preventing the formation of gel in a reaction vessel during the polymerization.

For example, the above hydrogenation is carried out under a pressurized hydrogen of 1 to 100 atmospheric pressure by using a catalyst selected from a hydrogenation catalyst such as an organic carboxylic acid nickel, an organic carboxylic acid cobalt and organometallic compounds of Group I-III; a catalyst of nickel, platinum, palladium, ruthenium or rhodium metal carried on carbon, silica, diatomaceous earth or the like; a complex of cobalt, nickel, rhodium or ruthenium; and so on.

The rubber composition according to the invention is required to use the component (A) as a matrix rubber component, but a usual rubber component may be blended into the component (A) and in particular natural rubber (NR), styrene-butadiene copolymer rubber (SBR), polyisoprene rubber (IR), polybutadiene rubber (BR), butyl rubber (IIR), ethylene-propylene copolymer or the like may be blended. Moreover, there may be blended a rubber component having a branch structure, in which a part thereof is modified with a polyfunctional modifying agent such as tin tetrachloride or the like. Among them, styrene-butadiene copolymer rubber (SBR) is preferable in view of the compatibility. The amount of the common rubber component used is preferably not more than 60% by mass in the rubber component (i.e., the sum of the component (A) and the common rubber component).

The rubber composition of the invention is preferable to be compounded with a reinforcing filler, not particularly limited, but is preferable to be compounded with carbon black and/or silica.

The silica is not particularly limited, but includes, for example, precipitated silica (hydrous silicate), fumed silica (anhydrous silicate), calcium silicate, aluminum silicate and so on. Among them, the precipitated silica is preferable in a point that the effect of improving fracture characteristics and the effect of establishing the wet gripping performance and the low rolling resistance are excellent. In the rubber composition of the invention, the silica may be only compounded as the filler. In this case, the amount of the silica compounded is 10 to 250 parts by mass based on 100 parts by mass of the rubber component, and preferably 20 to 150 parts by mass from a viewpoint of the reinforcing property and the improvement efficiency of various characteristics. When the amount of the silica compounded is less than 10 parts by mass based on 100 parts by mass of the rubber component, the fracture characteristics and the like are not sufficient, while when it exceeds 250 parts by mass, the processability of the rubber composition is deteriorated.

When the silica is used as the filler in the rubber composition of the invention, it is preferable that a silane coupling agent is added on compounding in view of further improving the reinforcing property. As the silane coupling agent are mentioned bis(3-triethoxysilylpropyl) tetrasulfide, bis(3-triethoxysilylpropyl) trisulfide, bis(3-triethoxysilylpropyl) disulfide, bis(2-triethoxysilylethyl) tetrasulfide, bis(3-trimethoxysilylpropyl) tetrasulfide, bis(2-trimethoxysilylethyl) tetrasulfide, 3-mercaptopropyltrimethoxy silane, 3-mercaptopropyltriethoxy silane, 2-mercaptoethyltrimethoxy silane, 2-mercaptoethyltriethoxy silane, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilylethyl-N,N-dimethylthiocarbamoyl tetrasulfide, 3-trimethoxysilylpropyl benzothiazole tetrasulfide, 3-triethoxysilylpropyl benzothiazole tetrasulfide, 3-triethoxysilylpropyl methacrylate monosulfide, 3-trimethoxysilylpropyl methacrylate monosulfide, bis(3-diethoxymethylsilylpropyl) tetrasulfide, 3-mercaptopropyl dimethoxymethyl silane, dimethoxymethylsilylpropyl-N,N-dimethylthiocarbamoyl tetrasulfide, dimethoxymethylsilylpropyl benzothiazole tetrasulfide and the like. Among them, bis(3-triethoxysilylpropyl) tetrasulfide and 3-trimethoxysilylpropyl benzothiazole tetrasulfide are preferable from a viewpoint of the effect of improving the reinforcing property. These silane coupling agents may be used alone or in a combination of two or more.

On the other hand, the carbon black is not particularly limited, but includes FEF, SRF, HAF, ISAF and SAF grade ones and the like. The carbon black preferably has an iodine adsorption number (IA) of not less than 60 mg/g and a dibutylphthalate (DBP) adsorption number of not less than 80 mL/100 g. Although the various characteristics of the rubber composition can be improved by compounding the carbon black, as the carbon black are more preferable HAF, ISAF and SAF grade carbon blacks in view of improving the wear resistance. In the rubber composition of the invention, the carbon black may be only compounded as the filler. In this case, the amount of the carbon black compounded is 10 to 250 parts by mass based on 100 parts by mass of the rubber component, and preferably 20 to 150 parts by mass from a viewpoint of the reinforcing property and the improvement efficiency of various characteristics. When the amount of the carbon black compounded is less than 10 parts by mass based on 100 parts by mass of the rubber component, the fracture characteristics and the like are not sufficient, while when it exceeds 250 parts by mass, the processability of the rubber composition is deteriorated.

A common crosslinking system for a rubber can be used in the rubber composition of the invention, and a combination of a crosslinking agent and a vulcanization accelerator is preferably used. As the crosslinking agent are mentioned sulfur and the like. The amount of the crosslinking agent used is preferable to be within a range of 0.1 to 10 parts by mass as a sulfur content, and more preferable to be within a range of 1 to 5 parts by mass based on 100 parts by mass of the rubber component. When the amount of the crosslinking agent compounded is 0.1 part by mass as the sulfur content based on 100 parts by mass of the rubber component, the breaking strength, wear resistance and low heat build-up of the resulting vulcanized rubber are deteriorated, while when it exceeds 10 parts by mass, the rubber elasticity is lost.

On the other hand, the vulcanization accelerator is not particularly limited, but includes a thiazole-based vulcanization accelerator such as 2-mercaptobenzothiazole (M), dibenzothiazyl disulfide (DM), N-cyclohexyl-2-benzothiazyl sulfenamide (CZ), N-t-butyl-2-benzothiazolyl sulfenamide (NS) or the like; a guanidine-based vulcanization accelerator such as diphenyl guanidine (DPG) or the like; and so on. The amount of the vulcanization accelerator used is preferably within a range of 0.1 to 5 parts by mass, more preferably within a range of 0.2 to 3 parts by mass based on 100 parts by mass of the rubber component. These vulcanization accelerators may be used alone or in a combination of two or more.

A processing oil or the like can be used as a softener in the rubber composition of the invention. As the processing oil are mentioned a paraffinic oil, a naphthenic oil, an aromatic oil and the like. Among them, the aromatic oil is preferable in view of the tensile strength and wear resistance, and the naphthenic oil and the paraffinic oil are preferable in view of the hysteresis loss and low-temperature characteristics. The amount of the processing oil used is preferable to be within a range of 0 to 100 parts by mass based on 100 parts by mass of the rubber component. When the amount of the processing oil used exceeds 100 parts by mass based on 100 parts by mass of the rubber component, the tensile strength and low heat build-up of the vulcanized rubber tend to be deteriorated.

In the rubber composition of the invention can be compounded additives usually used in the rubber industry such as an anti-aging agent, zinc oxide, stearic acid, an antioxidant, an antiozonant and the like within a scope of not damaging the object of the invention in addition to the components (A) and (B), the common rubber component, the filler, the silane coupling agent, the crosslinking agent, the vulcanization accelerator and the softener.

The rubber composition of the invention is obtained by milling with a milling machine such as rolls, an internal mixer or the like, which can be shaped and vulcanized for use in tire applications such as a tread, an under tread, a carcass, a sidewall, a bead and the like as well as a rubber cushion, a belt, a hose and other industrial products, but it is particularly suitable for use in the tire tread.

The pneumatic tire according to the invention is characterized by using the above rubber composition in a tread rubber. The tire has good fracture resistance and wear resistance and excellent steering stability because the aforementioned rubber composition having the high hysteresis loss (tan δ) and the good wear resistance and fracture characteristics is applied to the tread rubber of the tire. The pneumatic tire according to the invention is not particularly limited as far as the above rubber composition is used for the tread rubber, and can be produced by the usual method. Moreover, as a gas filled into the tire can be used usual air or air having a regulated partial oxygen pressure but also inert gases such as nitrogen, argon, helium and so on.

### EXAMPLES

The following examples are given in illustration of the invention and are not intended as limitations thereof.

Copolymers (A-1)-(A-4) and copolymers (B-1)-(B-3) are synthesized by the following method, and the bound styrene content, vinyl bond content, weight average molecular weight as converted to polystyrene and hydrogenation ratio are measured by the following method.

(1) Bound Styrene Content

The bound styrene content of the synthesized copolymer is calculated from an integral ratio of ¹H-NMR spectrum.

(2) Vinyl Bond Content

The vinyl bond content in the butadiene portion of the synthesized copolymer is analyzed by an infrared method.

(3) Weight Average Molecular Weight as Converted to Polystyrene (Mw)

The weight average molecular weight as converted to polystyrene of the synthesized copolymer is measured by a GPC. In the measurement, 244 model GPC made by Waters Corp. is used as the GPC, a differential refractometer is used as a detector, GMH-3, GMH-6 and G6000H-6 columns made by TOSOH Corporation are used as a column, and tetrahydrofuran is used as a mobile phase. Further, the polystyrene-converted molecular weight of the copolymer is determined by using a calibration curve which is previously prepared by using a monodisperse styrene polymer made by Waters Corp. and determining a relation between molecular weight of peak of the monodisperse styrene polymer through GPC and count number of GPC.

(4) Hydrogenation Ratio The hydrogenation ratio in the butadiene portion of the synthesized copolymer is calculated from a reduction of an unsaturated bond portion in a spectrum of 100 Mhz ¹H-NMR measured at a concentration of 15% by mass with using carbon tetrachloride as a solvent.

<Synthesis of Copolymer (A-1)>

In an autoclave of 5 liters sufficiently purged with nitrogen and provided with a stirring blade are charged 3000 g of cyclohexane, 12 g of tetrahydrofuran (THF), 186 g of 1,3-butadiene and 114 g of styrene, and a temperature inside the autoclave is adjusted to 21° C. Then, 0.10 g of n-butyllithium is added to conduct polymerization under a temperature rising condition for 60 minutes, and the conversion of the monomer is confirmed to be 99%. Thereafter, 3.5 g of 2,6-di-t-butyl-p-cresol is added as an antioxidant to obtain a copolymer (A-1). The analytical values are shown in Table 1.

<Synthesis of Copolymer (A-2)>

In an autoclave of 5 liters sufficiently purged with nitrogen and provided with a stirring blade are charged 3000 g of cyclohexane, 12 g of tetrahydrofuran (THF), 186 g of 1,3-butadiene and 114 g of styrene, and a temperature inside the autoclave is adjusted to 21° C. Then, 0.10 g of n-butyllithium is added to conduct polymerization under a temperature rising condition for 60 minutes, and the conversion of the monomer is confirmed to be 99%. Further, a catalyst solution of nickel naphthenate:triethylaluminum:butadiene=1:3:3 (molar ratio) previously prepared in another vessel is charged so as to become 1 mole of nickel per 1000 moles of butadiene portion in the copolymer. Thereafter, hydrogen is introduced into the reaction system under a hydrogen pressure of 30 kg/cm to conduct the reaction at 80° C. Then, 3.5 g of 2,6-di-t-butyl-p-cresol is added as an antioxidant to obtain a copolymer (A-2). The analytical values are shown in Table 1.

<Synthesis of Copolymers (A-3)-(A-4)>

Copolymers (A-3)-(A-4) are synthesized in the same manner as in the copolymer (A-2) except that the hydrogen pressure and hydrogenation time are changed. The analytical values are shown in Table 1.

<Synthesis of Copolymer (B-1)>

In an autoclave of 5 liters sufficiently purged with nitrogen and provided with a stirring blade are charged 3000 g of cyclohexane, 12 g of tetrahydrofuran (THF), 200 g of 1,3-butadiene and 100 g of styrene, and a temperature inside the autoclave is adjusted to 21° C. Then, 1.50 g of n-butyllithium is added to conduct polymerization under a temperature rising condition for 60 minutes, and the conversion of the monomer is confirmed to be 99%. Thereafter, 4.68 g of tributylsilyl chloride is added to stop the polymerization to obtain a copolymer (B-1). The analytical values are shown in Table 1.

<Synthesis of Copolymer (B-2)>

In an autoclave of 5 liters sufficiently purged with nitrogen and provided with a stirring blade are charged 3000 g of cyclohexane, 12 g of tetrahydrofuran (THF), 200 g of 1,3-butadiene and 100 g of styrene, and a temperature inside the autoclave is adjusted to 21° C. Then, 1.50 g of n-butyllithium is added to conduct polymerization under a temperature rising condition for 60 minutes, and the conversion of the monomer is confirmed to be 99%. Thereafter, 4.68 g of tributylsilyl chloride is added to stop the polymerization, and a catalyst solution of nickel naphthenate:triethylaluminum:butadiene=1:3:3 (molar ratio) previously prepared in another vessel is charged so as to become 1 mole of nickel per 1000 moles of butadiene portion in the copolymer. Thereafter, hydrogen is introduced into the reaction system under a hydrogen pressure of 30 atm to conduct the reaction at 80° C., and as a result a copolymer (B-2) is obtained. The analytical values are shown in Table 1.

<Synthesis of Copolymer (B-3)>

A copolymer (B-3) is synthesized in the same manner as in the copolymer (B-2) except that the hydrogen pressure and hydrogenation time are changed. The analytical values are shown in Table 1.

TABLE 1

| | Bound styrene | Vinyl bond | Weight average | Hydro- |
|---|---|---|---|---|
| | content | content | molecular | genation |
| | (mass %) | (%) | weight | ratio (%) |
| Copolymer | 38 | 35 | 400 × 10³ | 0 |
| (A-1) | | | | |
| Copolymer | 38 | 36 | 410 × 10³ | 31 |
| (A-2) | | | | |
| Copolymer | 38 | 35 | 410 × 10³ | 51 |
| (A-3) | | | | |
| Copolymer | 38 | 35 | 400 × 10³ | 70 |
| (A-4) | | | | |
| Copolymer | 33 | 40 | 15 × 10³ | 0 |
| (B-1) | | | | |
| Copolymer | 33 | 40 | 15 × 10³ | 49 |
| (B-2) | | | | |
| Copolymer | 33 | 42 | 15 × 10³ | 85 |
| (B-3) | | | | |

Then, a rubber composition having a compounding recipe as shown in Table 2 is prepared according to a usual method by using the above copolymers (A-1)-(A-4) and (B-1)-(B-3), and then the wear resistance, steering stability and fracture resistance of the resulting rubber composition are evaluated by the following methods. The results are shown in Table 2.

(5) Wear Resistance

The wear resistance is evaluated by measuring a worn amount at a slip ratio of 60% and room temperature by means of a Lambourn abrasion tester, which is shown by an index on the basis that the worn amount of the rubber composition in Comparative Example 1 is 100. The larger the index value, the less the worn amount and the more excellent the wear resistance.

(6) Steering Stability

Tan δ is measured at a shear strain of 5%, a temperature of 60° C. and a frequency of 15 Hz by using a mechanical spectrometer manufactured by RHEOMETRICS Corporation, which is shown by an index on the basis that the tan δ of the comparative Example 1 is 100. The larger the index value, the larger the hysteresis loss and the better the steering stability.

(7) Fracture Resistance

A tensile test is conducted according to JIS K 6301-1995 to measure a tensile strength (Tb) of a vulcanized rubber composition, which is shown by an index on the basis that the tensile strength of Comparative Example 1 is 100. The larger the index value, the better the fracture resistance.

TABLE 2

| | | Comparative | Comparative | Comparative | Comparative | Comparative | Example | Example | Example | Example |
|---|---|---|---|---|---|---|---|---|---|---|
| | | Example 1 | Example 2 | Example 3 | Example 4 | Example 5 | 1 | 2 | 3 | 4 |
| Copolymer | parts by | 100 | 100 | 100 | — | — | — | — | — | — |
| (A-1) | mass | | | | | | | | | |
| Copolymer | | — | — | — | — | — | 100 | — | 100 | — |
| (A-2) | | | | | | | | | | |
| Copolymer | | — | — | — | — | 100 | — | 100 | — | 100 |
| (A-3) | | | | | | | | | | |
| Copolymer | | — | — | — | 100 | — | — | — | — | — |
| (A-4) | | | | | | | | | | |
| Aromatic oil | | — | — | — | — | 30 | — | — | — | — |
| Copolymer | | 30 | — | — | — | — | — | — | 30 | — |
| (B-1) | | | | | | | | | | |
| Copolymer | | — | 30 | — | — | — | — | — | — | 30 |
| (B-2) | | | | | | | | | | |
| Copolymer | | — | — | 30 | 30 | — | 30 | 30 | — | — |
| (B-3) | | | | | | | | | | |
| Carbon black *1 | | 65 | 65 | 65 | 65 | 65 | 65 | 65 | 65 | 65 |
| Stearic acid | | 2 | 2 | 2 | 2 | 2 | 2 | 2 | 2 | 2 |
| Zinc white | | 3 | 3 | 3 | 3 | 3 | 3 | 3 | 3 | 3 |
| Antioxidant 6C *2 | | 1 | 1 | 1 | 1 | 1 | 1 | 1 | 1 | 1 |
| Vulcanization | | 0.5 | 0.5 | 0.5 | 0.5 | 0.5 | 0.5 | 0.5 | 0.5 | 0.5 |
| accelerator DM *3 | | | | | | | | | | |
| Vulcanization | | 1 | 1 | 1 | 1 | 1 | 1 | 1 | 1 | 1 |
| accelerator NS *4 | | | | | | | | | | |
| Sulfur | | 1.8 | 1.8 | 1.8 | 2.8 | 2.5 | 1.8 | 2.5 | 1.8 | 2.5 |
| Wear resistance | index | 100 | 99 | 98 | 60 | 94 | 105 | 112 | 105 | 105 |
| Steering stability | index | 100 | 118 | 128 | 120 | 90 | 135 | 138 | 130 | 136 |
| Fracture resistance | index | 100 | 92 | 85 | 65 | 90 | 110 | 105 | 113 | 115 |

*1 ISAF, SEAST 3H made by TOKAI CARBON CO., LTD.
*2 N-(1,3-dimethylbutyl)-N′-phenyl-p-phenylenedamine, “NOCRAC 6C” made by OUCHISHINKO CHEMICAL INDUSTRIAL CO., LTD.
*3 Dibenzothiazyl disulfide.
*4 N-t-butyl-2-benzothiazolyl sulfenamide, “NOCCELER NS” made by OUCHISHINKO CHEMICAL INDUSTRIAL CO., LTD.

As seen from the results of the examples in Table 2, the rubber compositions formed by compounding the low-molecular weight aromatic vinyl compound-conjugated diene compound copolymer (component B) having the specified molecular weight into the high-molecular weight aromatic vinyl compound-conjugated diene compound copolymer (component A) having the molecular weight and hydrogenation ratio specified in the invention can highly improve the steering stability while improving the fracture resistance and wear resistance.

To the contrary, as seen from the results of the comparative examples 2 and 3, when the hydrogenated low-molecular weight aromatic vinyl compound-conjugated diene compound copolymer is compounded into the unhydrogenated high-molecular weight aromatic vinyl compound-conjugated diene compound copolymer, the fracture resistance and wear resistance of the rubber composition are deteriorated. Also, as seen from the results of the comparative example 4, when the hydrogenated low-molecular weight aromatic vinyl compound-conjugated diene compound copolymer is compounded into the excessively hydrogenated high-molecular weight aromatic vinyl compound-conjugated diene compound copolymer, the wear resistance and fracture resistance of the rubber composition are significantly deteriorated. Further, as seen from the results of the comparative example 5, the rubber composition formed by compounding the aromatic oil into the high-molecular weight aromatic vinyl compound-conjugated diene compound copolymer (component A) having the molecular weight and hydrogenation ratio specified in the invention has inferior wear resistance, steering stability and fracture resistance as compared with the comparative example 1.

1. A rubber composition comprising 10 to 200 parts by mass of a component (B): an aromatic vinyl compound-conjugated diene compound copolymer or a conjugated diene compound polymer having a weight average molecular weight as measured through a gel permeation chromatography and converted to polystyrene of 1.0×10³ to 2.0×10⁵ based on 100 parts by mass of a component (A): an aromatic vinyl compound-conjugated diene compound copolymer or a conjugated diene compound polymer having a weight average molecular weight as measured through a gel permeation chromatography and converted to polystyrene of 3.0×10⁵ to 3.0×10⁶,
wherein not less than 10% but less than 60% of an unsaturated bond in a conjugated diene compound portion of the component (A) is hydrogenated.

2. A rubber composition according to claim 1, wherein the component (A) is one formed by polymerizing with a lithium-based polymerization initiator.

3. A rubber composition according to claim 1, wherein the component (A) is styrene-butadiene copolymer.

4. A rubber composition according to claim 3, wherein a bound styrene content of the component (A) is 20 to 40% by mass.

5. A rubber composition according to claim 3, wherein a vinyl bond content in a butadiene portion of the component (A) is 30 to 60%.

6. A rubber composition according to claim 1, wherein 30% to 50% of the unsaturated bond in the conjugated diene compound portion of the component (A) is hydrogenated.

7. A rubber composition according to claim 1, wherein a bound styrene content of the component (B) is 0 to 60% by mass.

8. A rubber composition according to claim 1, wherein 20% to 100% of an unsaturated bond in a conjugated diene compound portion of the component (B) is hydrogenated.

9. A rubber composition according to claim 8, wherein 40% to 90% of the unsaturated bond in the conjugated diene compound portion of the component (B) is hydrogenated.

10. A rubber composition according to claim 1, wherein the component (B) has a number average molecular weight as measured through a gel permeation chromatography and converted to polystyrene of not less than 2000 but less than 30000.

11. A rubber composition according to claim 1, which comprises 10 to 100 parts by mass of the component (B) based on 100 parts by mass of the component (A).

12. A pneumatic tire characterized by using a rubber composition as claimed in any one of claims 1-11 in a tread rubber.
